(19) United States
(12) Patent Application Publication
(10) Pub. No.: US 2005/0077662 A1
(43) Pub. Date: Apr. 14, 2005

(54) Intergrated channel plate and decoupler assembly for vibration isolator

(76) Inventors: John F Garety, Auburn, IN (US); Brian E. Koomler, Woodburn, IN (US)

Correspondence Address: Timothy E Nauman;Fay Sharpe Fagan Minnich & McKee, 7th Floor, 1100 Superior Avenue, Cleveland, OH, 44114-2518, US

(21) Appl. No.: 10/503,560

(22) PCT Filed: Feb. 4, 2003
(86) PCT No.: PCT/US03/03439

Related U.S. Application Data
(60) Provisional application No. 60/354,160, filed on Feb. 4, 2002.

(51) Int. Cl. F16F 5/00

(52) U.S. Cl. 267/140.13

(57) ABSTRACT

An integrated plate assembly and method for forming an engine mount assembly comprises a unitary molded plate having an elongated fluid channel communicating between first and second sides of the plate. A cavity formed therein communicates with the first and second sides of the plate. The cavity receives a decoupling member having first and second surface areas facing outwardly toward the first and second sides of the plate.

### BACKGROUND OF THE INVENTION

This application claims the priority benefit of and hereby expressly incorporates by reference U.S. provisional application Ser. No. 60/354,160, filed Feb. 4, 2002.

This application relates to a vibration isolator, and more particularly to an integrated channel plate and decoupler assembly used in a vibration isolator.

Vibration isolators or engine mounts are well known in the automotive industry for controlling or attenuating vibrations related to engine and/or road conditions. Typically, the vibration isolator is a fluid filled assembly mounted, for example, between an engine and a vehicle frame. First and second chambers of the isolator are separated by a channel plate that has an elongated channel providing fluid communication between the chambers. The channel allows fluid to oscillate between the chambers and provides a desired dynamic stiffness in response to a selective range of frequencies. For example, large amplitude and low frequency vibrations are effectively dampened and the desired stiffness is provided as a result of the fluid passing through the elongated channel. It is also known in the art, for example as shown and described in U.S. Pat. Nos. 4,720,086 and 4,889,325, to use a decoupling means to selectively inactivate or decouple the elongated channel at selected amplitudes and frequencies. Typically, the decoupling means includes a diaphragm or disk (decoupler) that controls fluid flow through an associated passage by oscillating in response to high frequency, low amplitude vibrations. At a certain amplitude/frequency the decoupler engages a seat and thus blocks flow through the associated passage and thereby requiring fluid to flow between the chambers through the elongated channel. Thus as is known in the art, small amplitude, high frequency vibrations require a low stiffness to filter these vibrations. The decoupler or decoupling means achieves this operation. On the other hand, larger amplitude and lower frequency vibrations require an increased stiffness. Accordingly, the decoupler forces the fluid to pass through the elongated channel to achieve this dampening function.

As will be appreciated, the channel plate, decoupler/high frequency washer are typically separate components. This adds to manufacturing and assembly costs. Thus, a need exists to reduce the number of components by integrating them into a single assembly in order to simplify the assembly and reduce costs associated with the manufacture and assembly of vibration isolators or engine mounts.

### SUMMARY OF INVENTION

An integrated plate assembly for use in a yieldable support assembly such as a hydraulic engine mount or vibration isolator includes a molded plate having an elongated fluid channel communicating between first and second sides, and a cavity formed in the plate, also in communication with the first and second sides of the plate. A decoupling member is received and integrally molded in the cavity.

The decoupling member in a preferred embodiment is an elastomeric member that deflects in response to forces imposed thereon.

The elongated fluid channel extends at least one revolution about the plate.

In a preferred arrangement, the fluid channel extends approximately seven hundred twenty degrees (720°) around the perimeter of the plate.

A method of forming a vibration isolating assembly comprises the steps of inserting a decoupler into a mold and introducing a polymer into the mold around the decoupler to form a plate that fixes the decoupler in three orthogonal axes relative to the plate.

The method includes the further step of introducing a cured elastomer decoupler into the mold.

The method includes the additional step of forming a perimeter channel in the plate.

The primary advantage of the invention is the reduction of the number of components in the assembly.

Still another advantage is the ability to reduce the cost associated with the assembly.

Still other advantages and benefits of the invention will become apparent to those skilled in the art upon reading and understanding the following detailed description.

### BRIEF DESCRIPTION OF DRAWINGS

FIG. 1 is a longitudinal cross-section of an engine mount assembly or vibration isolator of the general type used to dampen vibrations.

FIG. 2 is a digital photograph of a prototype integrated plate assembly for use in an engine mount.

FIG. 3 is a plan view of a first or upper surface of the plate assembly.

FIG. 4 is an elevational view of the integrated plate assembly.

FIG. 5 is a bottom plan view of the integrated plate assembly.

FIG. 6 is a cross-sectional view generally along the lines 6-6 of FIG. 3.

FIG. 7 is a sectional view taken generally along the lines 7-7 of FIG. 4.

FIG. 8 is a sectional view taken generally along the lines 8-8 of FIG. 3.

FIG. 9 is a sectional view taken generally along the lines 9-9 of FIG. 4.

FIG. 10 is a sectional view taken generally along the lines 10-10 of FIG. 3.

FIG. 11 is a sectional view taken generally along the lines 11-11 of FIG. 3.

FIG. 12 is a graphical representation of the damping characteristics of the vibration isolator plotting dynamic stiffness (Newtons per millimeter) relative to the frequency (Hertz).

### DETAILED DESCRIPTION OF THE INVENTION

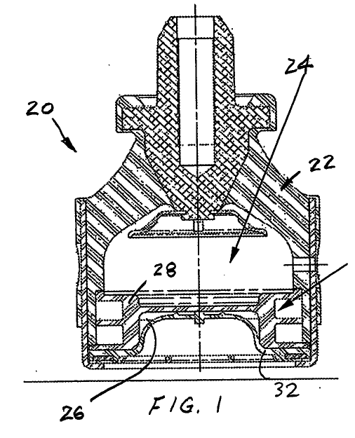

FIG. 1 generally illustrates a vibration isolator or dampening assembly, also referred to as a hydraulic engine mount assembly such as used in an automotive vehicle. As is known in the art, the engine mount assembly 20 includes a first housing portion 22 having a first or upper chamber 24 and a second or lower chamber 26 separated by a channel plate 28. A fluid such as a hydraulic fluid comprised of, for example, propylene glycol or a mixture of ethylene glycol and water, fills the chambers. The chambers are interconnected via a channel or passageway 30 provided in the channel plate. As is conventional in the art, the channel is an arcuate passage that is also referred to as an inertia track passageway that impacts on the resonant frequency of the fluid in the mount assembly. Typically, the channel has a substantially uniform cross-section throughout its entire length and is normally disposed along or adjacent an outer periphery of the plate with multiple windings to maximize the length of the channel. Oscillating movement imposed on the upper portion of the housing is dampened through fluid movement from the upper chamber, through the channel, and into the lower chamber which is enclosed by a flexible wall 32. The oscillation of the fluid in the channel between the first and second chamber provides the desired dynamic stiffness of the mount assembly. Details of the assembly of FIG. 1 are generally conventional and understood by one skilled in the art so that further discussion herein is deemed unnecessary.

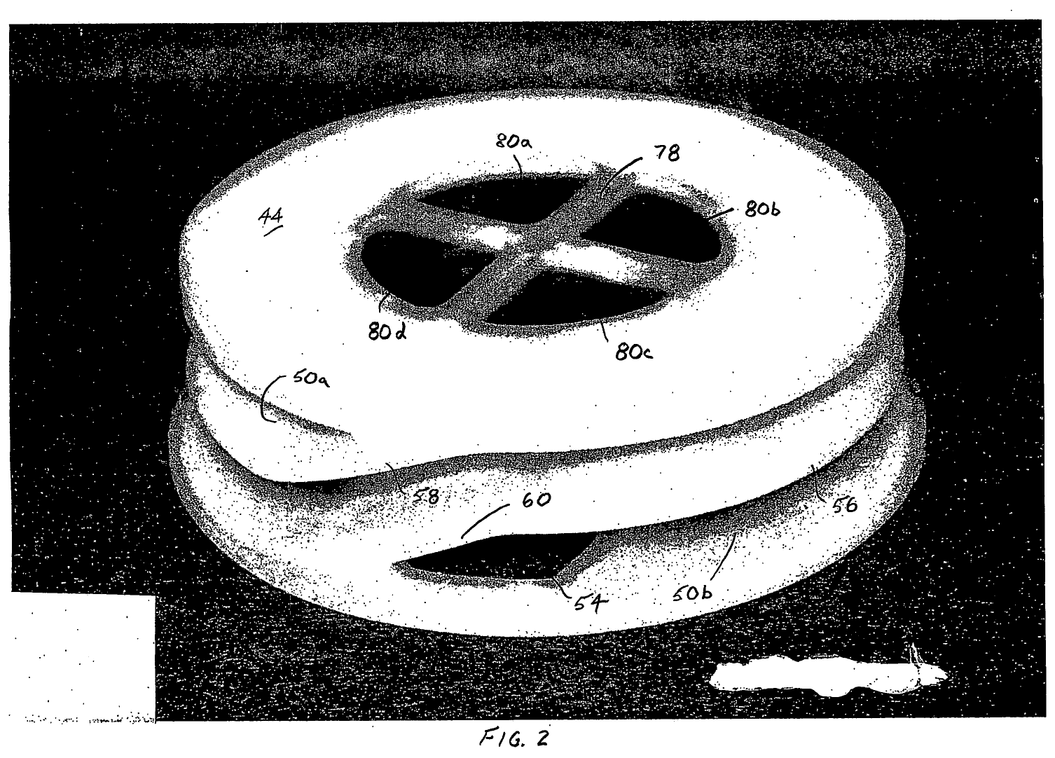

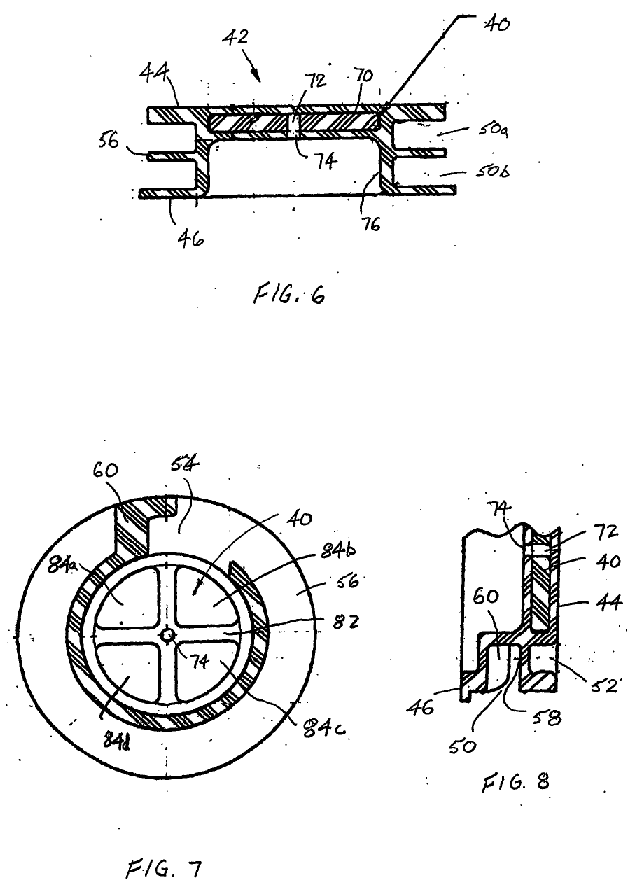

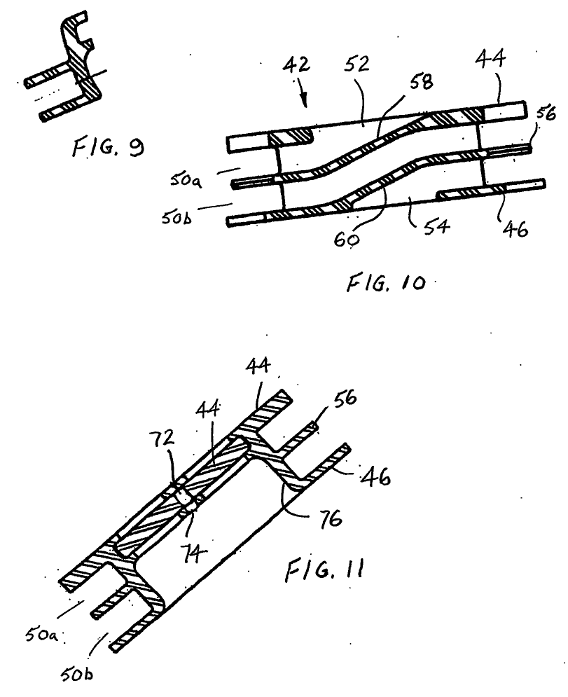

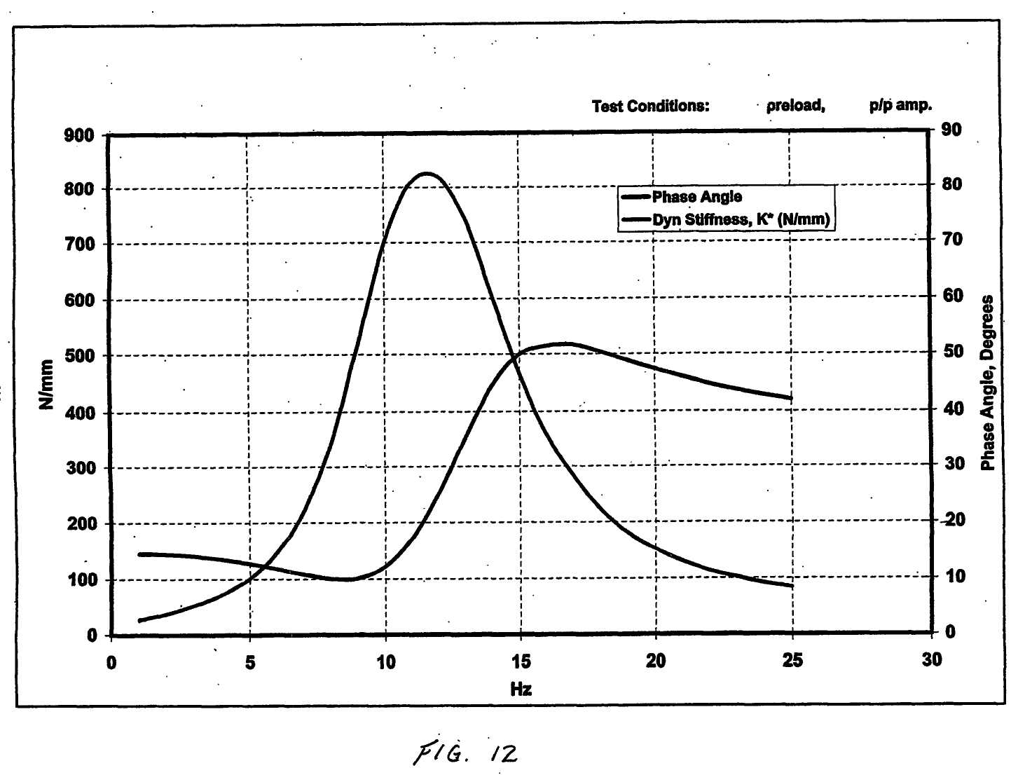

As noted above, it is desirable to selectively decouple or deactivate the channel during certain frequencies/amplitudes of vibrations. This is achieved through use of a decoupling means, decoupling member, or decoupler 40 (not shown in FIG. 1) incorporated into the present invention as shown in FIGS. 2-11. More specifically, the prior art suggests that the decoupling means is preferably an elastomeric member or disk, and on occasion the decoupling means includes a cage containing a particulate matter that selectively blocks and allows fluid flow to the inertia channel. As shown in FIG. 2, decoupler 40 is an elastomeric disk that is integrally molded in polymeric channel plate 42. This construction offers a number of advantages over the prior art arrangement.

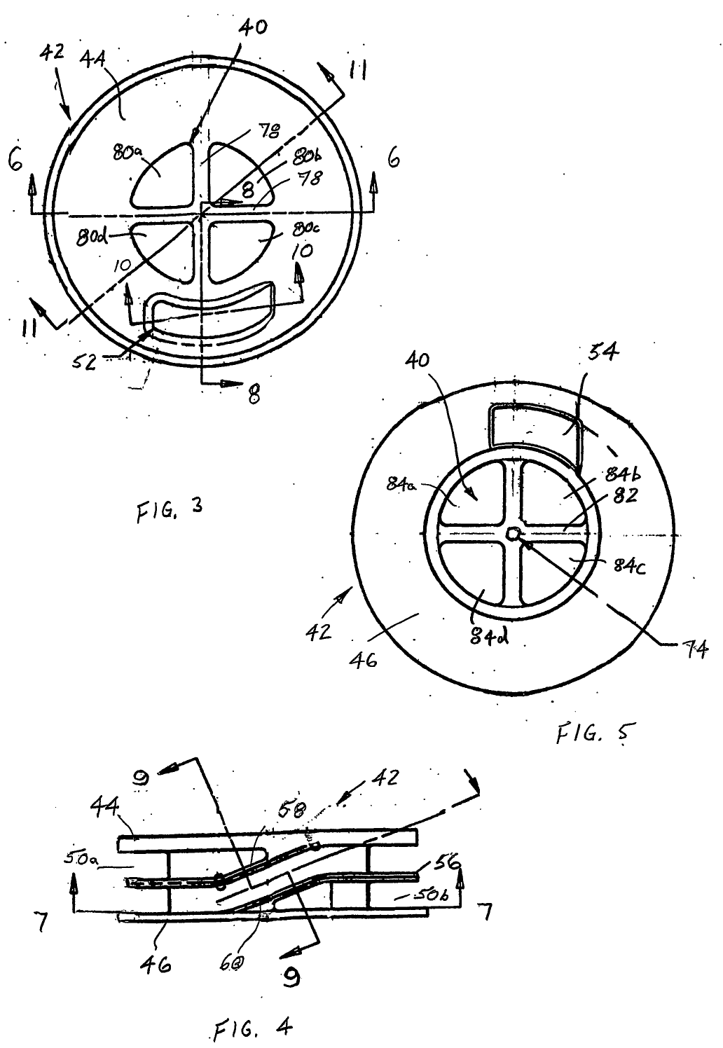

More particularly, the channel plate is a polymeric or plastic construction having a first or upper surface 44 (FIG. 3) and an opposed second or lower surface 46 (FIG. 5). An outer peripheral portion 48 of the plate includes a continuous channel, groove, or passage that serves as the inertia passageway 50 in the plate (FIG. 4). As is evident in FIG. 3, a first end of the channel communicates with or forms an opening 52 in the upper surface of the plate that is in fluid communication with the upper chamber 24. Likewise, a second end communicates with or forms an opening 54 in the lower surface 46 of the plate to provide fluid communication with the lower chamber 26 of the assembly. The channel extends approximately seven hundred and twenty degrees (720°) in its peripheral path about the plate, although it will be appreciated that other channel lengths can be used without departing from the scope and intent of the invention. The channel is provided by channel forming wall 56 that extends approximately mid-height between the upper and lower surfaces around a substantial perimeter of the plate and dividing the perimeter into a first/upper flight 50a and a second or lower flight 50b. Although only two flights are illustrated, it will be appreciated that the channel may include a greater or lesser number to respectively increase or decrease the length of the channel as required for a particular application. With reference to FIG. 4, the dividing wall 56 includes a first angled portion 58 that merges into the upper surface 44 of the plate at a circumferential position located adjacent the opening 52. Additionally, a second angled portion 60 merges from the dividing wall into the lower surface 46 of the plate adjacent the opening 52 therein. In this manner, fluid from the upper chamber proceeds through opening, then travels approximately three hundred and sixty degrees (360°) in the upper flight 50a of the channel then proceeds between the angled portions 58, 60, through another three hundred and sixty degree (360°) traverse on the lower flight 50b, and through the opening 54 in the bottom surface of the plate. In this manner, and under selected amplitude and frequency of vibration, the upper and lower chambers communicate through the inertial passage or channel.

Integrally molded into the plate is the decoupling means or decoupler 40. As shown throughout FIGS. 2-11, the decoupling means of the present invention is preferably an elastomeric disk. It is encased within the polymeric channel plate by integrally molding the cured decoupler in a cavity 70 adjacent the upper surface 44 of the plate. The cavity 70 is substantially identical in dimension and volume to that of the elastomeric member. This is achieved in the following manner. A small diameter opening 72 is preferably formed in the decoupler. This opening allows the decoupler to be held in place within a mold cavity (not shown) on a similarly dimensioned pin (not shown) and held within the mold cavity in a desired spatial relationship relative to the mold walls. Polymeric material that when cured forms the channel plate is introduced into the mold cavity and around the decoupler. Once the polymer is cured, the decoupler is held or maintained in fixed relation relative to the plate in three orthogonal, axial directions. A matingly located opening 74 is formed in a recess portion 76 of the lower surface 46 of the plate. As will be appreciated, the openings 72, 74 are axially aligned and representative of the location of the pin which holds the decoupler in position during molding of the channel plate therearound. Once the polymer is sufficiently cured, the pin is axially removed, thus leaving the voids or openings 72, 74. The upper surface of the decoupler, on the other hand, is restrained from axial movement via a cruciform pattern 78 formed in the channel plate (FIG. 3). Four enlarged quadrants 80a, 80b, 80c, 80d, are formed between the cruciform pattern and expose a substantial surface area of the upper surface of the decoupler to the fluid in the upper chamber 24. Similarly, as illustrated in FIG. 5, a cruciform pattern 82 defines four enlarged openings or lobes 84a, 84b, 84c, 84d so that a lower surface of the decoupler is exposed to fluid pressure in the lower chamber 26. It will be appreciated that the pattern of the plate holding the decoupler in fixed relation thereto may be varied from the cruciform relation as shown.

Thus, integrating the decoupler with an inertia channel allows the mounting assembly to provide dynamic stiffness in response to both small amplitudes of vibration and typically high frequency, as well as large amplitudes typically at a low frequency. The small amplitude/high frequency vibrations are handled by the elastic nature of the decoupler, while the large amplitude/low frequency vibrations are dampened through the inertia channel.

As illustrated in FIG. 12, at low frequencies, the inertia channel is decoupled and fluid oscillates through the channel between the upper and lower chambers. As the oscillation frequencies increase, however, the decoupler dampens the vibrations as a result of the elastic nature of the decoupler.

According to the preferred method of assembly, the decoupler is inserted and held in fixed relationship in the mold. The polymer of the channel plate is then introduced into the mold around the decoupler and fixes the decoupler in three orthogonal axes relative to the plate. Once the polymer is cured, the pin is removed from the decoupler. As will be appreciated, the decoupler is inserted into the mold preferably as a cured elastomer material and the polymer used to form the channel plate forms the perimeter channel or passage in the plate as a result of the inner wall configuration of the mold.

An integrated channel plate assembly thus forms the combined components of the channel plate and decoupler/high frequency washer into one component. The integration is preferably achieved by molding the polymer around an inserted rubber disk. The polymer is molded into the shape of a channel plate with the rubber decoupler disk captured in place by the surrounding polymer and by the mold core. By designing the part so that the rubber disk is encased in polymer around its outer diameter and in a crossing pattern on the top and bottom, the disk is held in place. The remaining surface area of the rubber disk is not covered with polymer and thereby allows a large surface area to be exposed to the fluid. During operation, the decoupler disk flexes as a result of the pressure of the fluid resulting in a lower dynamic stiffness, i.e., function of decoupling. The functionality of separate components as used in the prior art is achieved with this integrated component.

The invention has been described with reference to the preferred embodiment and method. Obviously, modifications and alterations will occur to others upon reading and understanding the preceding detailed description. It is intended that the invention be construed as including all such modifications and alterations.

1. An integrated plate assembly for use in a yieldable support, the assembly comprising:
a unitary, molded plate having first and second sides, and an elongated fluid path communicating between the first and second sides, and a cavity formed in the plate communicating with the first and second sides of the plate; and
a decoupling member received in the cavity and having first and second surfaces facing outwardly toward the first and second sides of the plate, respectively.

2. The assembly of claim 1 wherein the decoupling member is sealingly received in the cavity to preclude fluid communication of the first side with the second side of the plate through the cavity.

3. The assembly of claim 2 wherein the decoupling member is partially supported along the first and second surfaces by the plate whereby the decoupling member deflects in response to forces imposed thereon.

4. The assembly of claim 3 wherein the decoupling member is an elastomeric member that elastically deflects in response to the forces imposed thereon.

5. The assembly of claim 2 wherein the plate includes support members extending across portions of the first and second surfaces of the flexible member to encase the flexible member in the plate and allow limited deflection along unsupported regions of the surfaces.

6. The assembly of claim 1 wherein the elongated fluid path includes a generally circumferentially extending channel.

7. The assembly of claim 6 wherein the circumferentially channel extends at least one revolution about the plate.

8. The assembly of claim 1 wherein the flexible member is formed from a resilient material.

9. The assembly of claim 8 wherein the flexible member is formed of rubber.

10. The assembly of claim 1 wherein the plate is formed of a rigid plastic.

11. The assembly of claim 1 wherein the elongated fluid path extends about a periphery of the flexible member.

12. A vibration isolating assembly adapted for use in an engine mount that includes a housing having first and second fluid chambers in selective communication with one another, the vibration isolating assembly comprising:
an integrally molded plate having a cavity enclosing a decoupler, the plate having a passage that communicates with the first fluid chamber at a first end and with the second fluid chamber at a second end whereby fluid is displaced from one of the fluid chambers to the other, and the decoupler encased within the plate with substantial first and second surface portions thereof exposed to the first and second fluid chambers, respectively.

13. The vibration isolating assembly of claim 12 wherein the decoupler is a resilient material.

14. The vibration isolating assembly of claim 12 wherein the passage includes a serpentine passage.

15. The vibration isolating assembly of claim 12 wherein the passage includes a peripheral channel formed in the molded plate.

16. The vibration isolating assembly of claim 15 wherein the passage extends greater than three hundred sixty degrees (360°) around the perimeter of the molded plate.

17. The vibration isolating assembly of claim 15 wherein the passage extends approximately seven hundred twenty degrees (720°) around the perimeter of the molded plate.

18. A method of forming a vibration isolating assembly comprising the steps of:
inserting a decoupler into a mold;
introducing a polymer into the mold around the decoupler to form a plate that fixes the decoupler in three orthogonal axes relative to the plate.

19. The method of claim 18 wherein the decoupler is a cured elastomer material before inserting into the mold.

20. The method of claim 18 wherein the polymer introducing step includes the step of forming a perimeter passage in the plate that communicates with first and second sides thereof.
